(19) United States
(12) Patent Application Publication
(10) Pub. No.: US 2011/0234561 A1
(43) Pub. Date: Sep. 29, 2011

(54) DISPLAY CONTROLLER AND METHOD FOR DRIVING LIQUID CRYSTAL DISPLAY PANEL

(75) Inventors: Syang-yun Tzeng, Wugu (TW); Wen-chi Lin, Wugu (TW)

(73) Assignee: HANNSTAR DISPLAY CORPORATION, Wugu (TW)

(21) Appl. No.: 13/030,280

(22) Filed: Feb. 18, 2011

(30) Foreign Application Priority Data
Mar. 24, 2010 (TW) 099108793

(51) Int. Cl. G06F 3/038; G09G 3/36

(52) U.S. Cl. 345/209; 345/87

(57) ABSTRACT

A display controller and a method for driving a liquid crystal display (LCD) panel are disclosed. The display controller is electrically connected to the LCD panel and comprises a data processor and a control signal generator. The method comprises the following steps: determining whether an image data signal is a first image data signal or a second image data signal; providing a first polarity signal to the panel when the image data signal is the first image data signal; and providing a second polarity signal to the panel when the image data signal is the second image data signal.

### FIELD OF THE INVENTION

The present invention relates to a display controller and a method for driving a liquid crystal display (LCD) panel, and more particularly, to a display controller and a method for driving an LCD panel capable of enhancing the display quality and reducing the power consumption.

### BACKGROUND OF THE INVENTION

Currently, LCDs have been widely applied in electrical products. A general driving method used for the LCDs may be, for example, dot inversion, frame inversion, column inversion and row inversion. Among these driving modes, the frame inversion is disadvantageous in that flicker is conspicuous, and the column inversion is also disadvantageous in that vertical strips readily appear. Therefore, the dot inversion and row inversion are frequently used for driving the LCDs. In particular, the dot inversion is often used in large-size LCDs.

Although the dot inversion can have a better display quality, it needs larger power consumption. On the other hand, the frame inversion has a screen flicker problem, but it needs less power consumption. However, most of the LCDs use a fixed driving method and thus have a worse display quality or high power consumption.

### SUMMARY OF THE INVENTION

Therefore, an aspect of the present invention is to provide a display controller and a method for driving an LCD panel for varying a frequency of a polarity signal corresponding to the characteristic of an image data signal, thereby enhancing the display quality and reducing the power consumption.

According to one embodiment of the present invention, the display controller is electrically connected to a liquid crystal display panel, wherein the display controller comprises a data processor configured to process an image data signal; and a control signal generator electrically connected to the data processor, wherein the control signal generator provides a first polarity signal to the liquid crystal display panel when the image data signal is a first image data signal, and the control signal generator provides a second polarity signal to the liquid crystal display panel when the image data signal is a second image data signal; wherein the frequency of the first polarity signal is larger than the frequency of the second polarity signal.

According to another embodiment of the present invention, the method for driving a liquid crystal display panel comprises the following steps: determining whether an image data signal is the first image data signal or a second image data signal; providing a first polarity signal when the image data signal is determined as the first image data signal; and providing a second polarity signal when the image data signal is determined as the second image data signal; wherein the frequency of the first polarity signal is larger than the frequency of the second polarity signal.

In one embodiment of the present invention, the first image data signal is a static image signal, and the second image data signal is a dynamic image signal.

In one embodiment of the present invention, the display controller further comprises a data receiving interface configured to receive an input signal, and the input signal comprises an image data signal and an input control signal.

In one embodiment of the present invention, the data processor includes a determining unit for determining whether the image data signal is the first image data signal or the second image data signal, and transmitting a polarity control signal to the control signal generator.

In one embodiment of the present invention, the determining unit includes a register for storing pixel data of the image data signal, and the image data signal is determined as the first image data signal when a variation ratio of the pixel data is less than a ratio threshold, and the image data signal is determined as the second image data signal when the variation ratio of the pixel data is larger than the ratio threshold.

In one embodiment of the present invention, the number of the pixel data is 8, 16 or 32.

In one embodiment of the present invention, the determining unit includes a register for storing pixel data of the image data signal, and the image data signal is determined as the first image data signal when a variation frequency of the pixel data is less than a ratio frequency, and the image data signal is determined as the second image data signal when the variation frequency of the pixel data is larger than the ratio frequency.

In one embodiment of the present invention, the control signal generator further provides a horizontal synchronization start signal (STH), a loading signal (Load), a gate clock signal (CPV), scanning start signals (STV) and an output enable signal (OE) to the liquid crystal display panel.

In one embodiment of the present invention, the liquid crystal display panel implements dot inversion or two line inversion when the control signal generator provides the first polarity signal.

In one embodiment of the present invention, the liquid crystal display panel implements frame inversion or column inversion when the control signal generator provides the second polarity signal.

In one embodiment of the present invention, the image data signal is determined before being inputted to the display controller, and the data processor provides a polarity control signal to the control signal generator according to a determining signal.

In one embodiment of the present invention, the control signal generator includes a multiplexer which outputs the first polarity signal or the second polarity signal according to a polarity control signal.

In one embodiment of the present invention, the frequency of the first polarity signal is equal to the frequency of a loading signal.

In one embodiment of the present invention, the frequency of the first polarity signal is one-half of the frequency of a loading signal.

In one embodiment of the present invention, the frequency of the second polarity signal is one-half of a refresh frame frequency.

In one embodiment of the present invention, the determining step comprises:

storing pixel data of a frame of the image data signal; and

comparing the pixel data of the frame with pixel data of a next frame for obtaining a variation ratio of the pixel data.

Therefore, the display controller and the driving method of the LCD panel of the present invention can provide the corresponding polarity signal having different frequencies according to the characteristic of the inputted image data signal for implementing an appropriate polarity inversion, thereby enhancing the display quality and reducing the power consumption.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram showing an LCD apparatus according to one embodiment of the present invention;

FIG. 2 is a cross-sectional view showing an LCD panel according to one embodiment of the present invention;

FIG. 3 is a schematic view showing the LCD panel according to one embodiment of the present invention;

FIG. 4 is a block diagram showing the display controller according to one embodiment of the present invention;

FIG. 5 is a schematic view showing the frame stored in the register of the determining unit according to one embodiment of the present invention;

FIG. 6 is a circuit block diagram showing the data processor and the control signal generator according to one embodiment of the present invention;

FIG. 7 is a timing chart showing the image data signal and the control signal according to one embodiment of the present invention;

FIG. 8 is a flow diagram showing a driving method according to one embodiment of the present invention; and

FIG. 9 is a circuit block diagram showing the display controller according to another embodiment of the present invention.

### DETAILED DESCRIPTION OF THE PREFERRED EMBODIMENT

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, like reference numerals indicate like components or items.

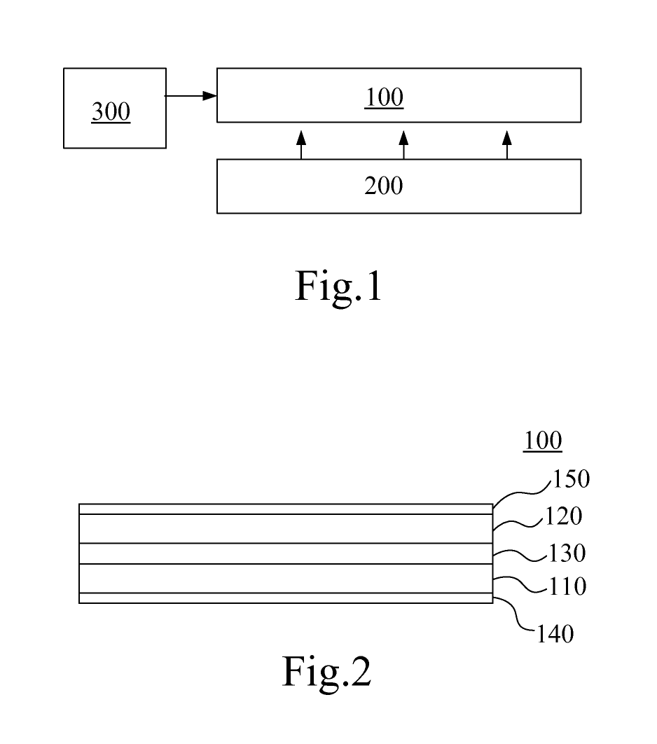

Referring to FIG. 1 and FIG. 2, FIG. 1 is a block diagram showing an LCD apparatus according to one embodiment of the present invention, and FIG. 2 is a cross-sectional view showing an LCD panel according to one embodiment of the present invention. The LCD apparatus comprises the LCD panel 100, a backlight module 200 and a display controller 300. The display controller 300 can be used to drive the LCD panel 100. The LCD panel 100 may be disposed on the backlight module 200. The LCD panel 100 may comprise a first substrate 110, a second substrate 120, a liquid crystal layer 130, a first polarizer 140 and a second polarizer 150. The first substrate 110 is disposed opposite to the second substrate 120, and the liquid crystal layer 130 is formed between the first substrate 110 and the second substrate 120. The first substrate 110 may be a thin-film transistor (TFT) array substrate, and the second substrate 120 may be a color filter (CF) substrate. However, in some embodiments, the CF and the TFT array can be arranged on the same substrate (i.e. color filter on array, COA). The first polarizer 140 is disposed at the outer side of the first substrate 110 and opposite to the liquid crystal layer 130. The second polarizer 150 is disposed at the outer side of the second substrate 120 and opposite to the liquid crystal layer 130.

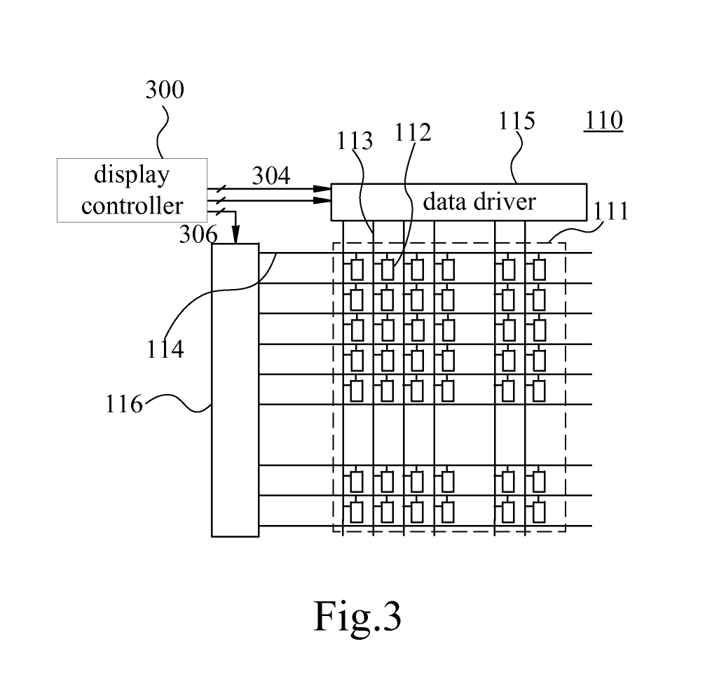

Referring to FIG. 3, a schematic view showing the LCD panel according to one embodiment of the present invention is illustrated. The first substrate 110 of the LCD panel 100 of the present embodiment comprises a substrate 111, a plurality of pixels 112, a plurality of data lines 113, a plurality of gate lines 114, a data driver 115 and a gate driver 116. The substrate 111 may be a glass substrate or a flexible plastic substrate. The data lines 113 and the gate lines 114 are arranged in a crisscross pattern on the substrate 111. The pixels 112 are arranged in a matrix manner on the substrate 110, and positioned between the data lines 113 and the gate lines 114. The data driver 115 is electrically connected to one side of the data lines 113 and includes data driving ICs (not shown) configured to drive the data lines 113. The gate driver 116 is electrically connected to one side of the gate lines 114 and includes gate driving ICs (not shown) configured to drive the gate lines 114.

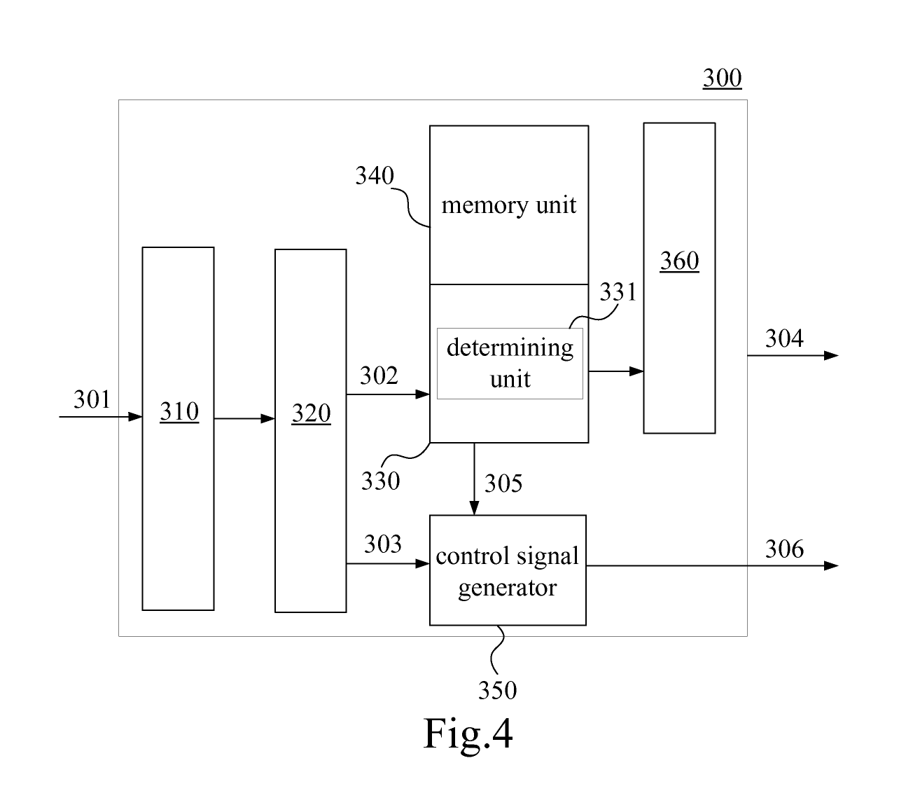

Referring to FIG. 3 and FIG. 4, FIG. 4 is a block diagram showing the display controller according to one embodiment of the present invention. The display controller 300 of the present embodiment may be a timing controller disposed on a circuit board, such as a printed circuit board (PCB), and electrically connected to the data driver 115 and the gate driver 116 of the first substrate 110 for driving the LCD panel 100. The display controller 300 comprises a data receiving interface 310, a data input latch 320, a data processor 330, a memory unit 340, a control signal generator 350 and a data transmitting interface 360. The data receiving interface 310 and the data transmitting interface 360 may be a RSDS interface, a TTL interface, a PPDS interface, an LVDS interface or a mini-LVDS interface. The data receiving interface 310 is configured to receive an input signal which is, for example, transmitted from at least one image processing circuit (not shown) of a system terminal, wherein the system terminal may be a computer system, an image capture system or any other device or equipment having the image processing circuit. The input signal 301 received by the receiving interface 310 may comprise an image data signal 302 and an input control signal 303 for controlling the display. The image data signal 302 may be R/G/B pixel data, and the input control signal 303 may comprise a pixel clock (CLK) signal, a horizontal synchronization (HSYNC) signal a vertical synchronization (VSYNC) signal and a display enable (DE). The data input latch 320 is used for latching the input signal 301 received by the receiving interface 310, transmitting the image data signal 302 to the data processor 330 and transmitting the input control signal 303 to the control signal generator 350. The data processor 330 is configured to process the image data signal 302, such as a sorting process for the R/G/B pixel data. The data processor 330 can provide a processed image data signal 304 to the data transmitting interface 360 for transmitting the processed image data signal 304 to the data driver 115 of the LCD panel 100 through the data transmitting interface 360. The memory unit 340 may be a memory device for store the data in process by the data processor 330.

Referring to FIG. 4 again, in this embodiment, the data processor 330 may include a determining unit 331 for determining whether the image data signal 302 is a first image data signal or a second image data signal, and transmitting a polarity control signal 305 to the control signal generator 350, wherein the first image data signal may be a static image signal, and the second image data signal may be a dynamic image signal. When determining by using the determining unit 331, the determining unit 331 may include a register (not shown) for storing the image data signal 302. The determining unit 331 can compare the pixel data of the image data signal 302 between two or more sequent frames. In this way, the determining unit 331 can determine whether the image data signal 302 is the first image data signal or the second image data signal according to a variation ratio of a variation frequency of the pixel data of the image data signal 302 between the two or more sequent frames.

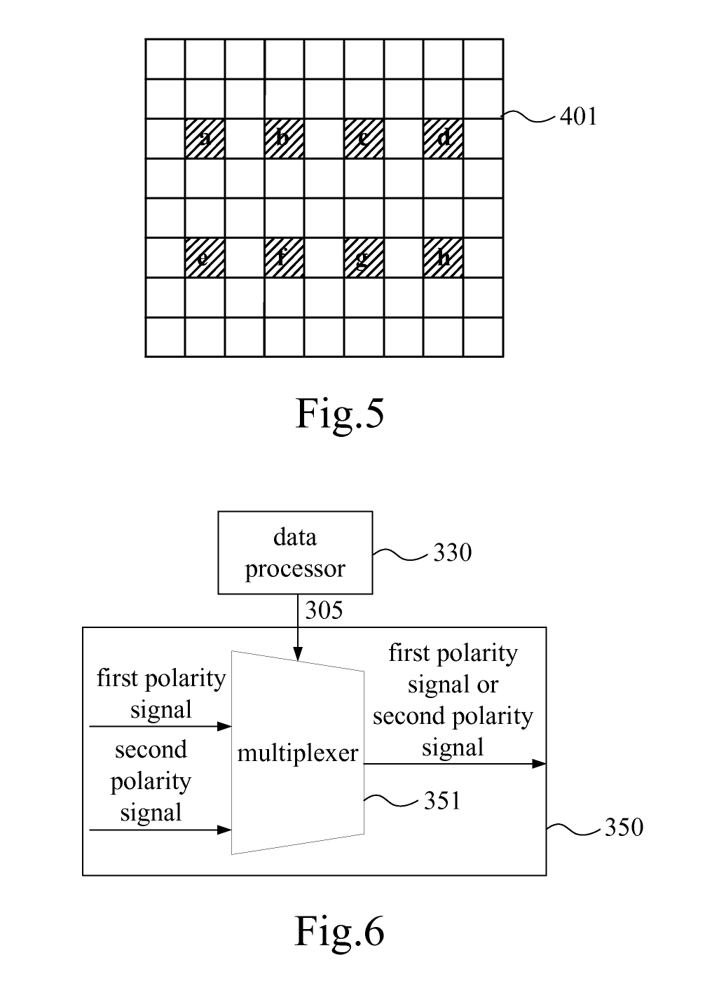

Referring to FIG. 4 and FIG. 5, FIG. 5 is a schematic view showing the frame stored in the register of the determining unit according to one embodiment of the present invention. For example, in one embodiment, the pixel data a-h of the image data signal 302 are stored in the register of the determining unit 331. The pixel data a-h are, for example, distributed in the frame 401. When the pixel data a-h of the next frame 401 are inputted, the determining unit 331 can calculate the variation ratio of the pixel data a-h between the two sequent frames 401, i.e. the ratio of the varied pixel data there-between. When the variation ratio of the pixel data a-h is less than a ratio threshold, the image data signal 302 is determined as the first image data signal (such as the static image signal). When the variation ratio of the pixel data a-h is larger than the ratio threshold, the image data signal 302 is determined as the second image data signal (such as the dynamic image signal). For example, the ratio threshold may be 50%, and the number of the pixel data a-h is eight. In this case, when the number of the varied pixel data is less than four, the image data signal 302 is determined as the first image data signal. On the contrary, when the number of the varied pixel data is more than four, the image data signal 302 is determined as the second image data signal. However, the number of the pixel data a-h in the register of the determining unit 331 is not limited to eight. In other embodiments, the number of the pixel data in the register of the determining unit 331 may be 16, 32 or more depended on the memory capacity of the register. Moreover, in n other embodiments, the ratio threshold may be 75% or higher.

In another embodiment, the determining unit 331 can implement the determination according to the variation frequency of the pixel data of the image data signal 302, wherein the variation frequency may be a data variation frequency of the pixel data in a predetermined period. When the variation frequency of the pixel data is less than a frequency threshold, the image data signal 302 is determined as the first image data signal (such as the static image signal). When the variation frequency of the pixel data is larger than the frequency threshold, the image data signal 302 is determined as the second image data signal (such as the dynamic image signal).

Referring to FIG. 4 and FIG. 6, FIG. 6 is a circuit block diagram showing the data processor and the control signal generator according to one embodiment of the present invention. The control signal generator 350 is electrically connected to the data processor 330 for generating a control signal 306 to the LCD panel 100. The control signal 306 provided by the control signal generator 350 may comprise a horizontal synchronization start signal (STH), a loading signal (Load), a gate clock signal (CPV), scanning start signals (STV), an output enable signal (OE) and a polarity signal (POL), wherein the polarity signal (POL) is provided to the data driver 115 of the LCD panel 100 for varying the polarity of the voltage applied to the data lines 113. The control signal generator 350 can correspondingly provide the polarity signal to the LCD panel 100 according to the polarity control signal 305 transmitted by the determining unit 331 of the data processor 330. When the image data signal 302 is the first image data signal, the control signal generator 350 can provide a first polarity signal to the LCD panel 100. When the image data signal 302 is the second image data signal, the control signal generator 350 can provide a second polarity signal to the LCD panel 100, wherein the frequency of the first polarity signal is larger than the frequency of the second polarity signal for varying a driving mode of the LCD panel 100. The driving mode may be dot inversion (1V1H inversion), frame inversion, column inversion, row inversion or two line inversion (2V1H inversion). Referring to FIG. 6 again, the control signal generator 350 may include a multiplexer 351 which can receive the first polarity signal and the second polarity signal simultaneously, and can output a corresponding polarity signal (the first polarity signal or the second polarity signal) to the LCD panel 100 according to the polarity control signal 305.

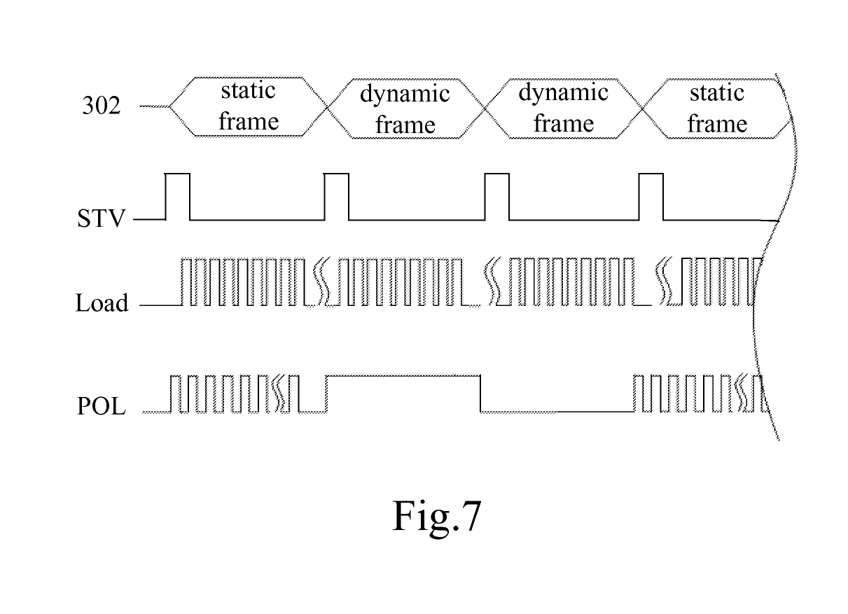

Referring to FIG. 7, a timing chart showing the image data signal and the control signal according to one embodiment of the present invention is illustrated. When the image data signal 302 of the input signal 301 is, for example, a static image signal (the first image data signal), i.e. when the input signal 301 is an image data with static frames, the control signal generator 350 can provide the first polarity signal with higher frequency for implementing dot inversion, two line inversion or other driving mode with higher inversion frequency, so as to meet the high display quality requirement of the static frames. Referring to FIG. 7 again, in this embodiment, the frequency of the first polarity signal may be equal to the frequency of the loading signal for dot inversion. In one embodiment, the frequency of the first polarity signal may be one-half of the frequency of the loading signal for two line inversion.

When the image data signal 302 of the input signal 301 is, for example, a dynamic image signal (the second image data signal), i.e. when the input signal 301 is an image data with dynamic frames, flicker or cross-talk is not readily noticeable, and thus the control signal generator 350 can provide the second polarity signal with lower frequency for implementing the frame inversion, column inversion or other driving mode with higher inversion frequency, so as to reduce the power consumption. Referring to FIG. 7 again, in this embodiment, the frequency of the second polarity signal may be one-half of a refresh frame frequency for column inversion.

Therefore, the display controller 300 and the LCD apparatus can provide the corresponding polarity signal to the LCD panel 100 according to different image data signals 302, thereby enhancing the display quality and reducing the power consumption.

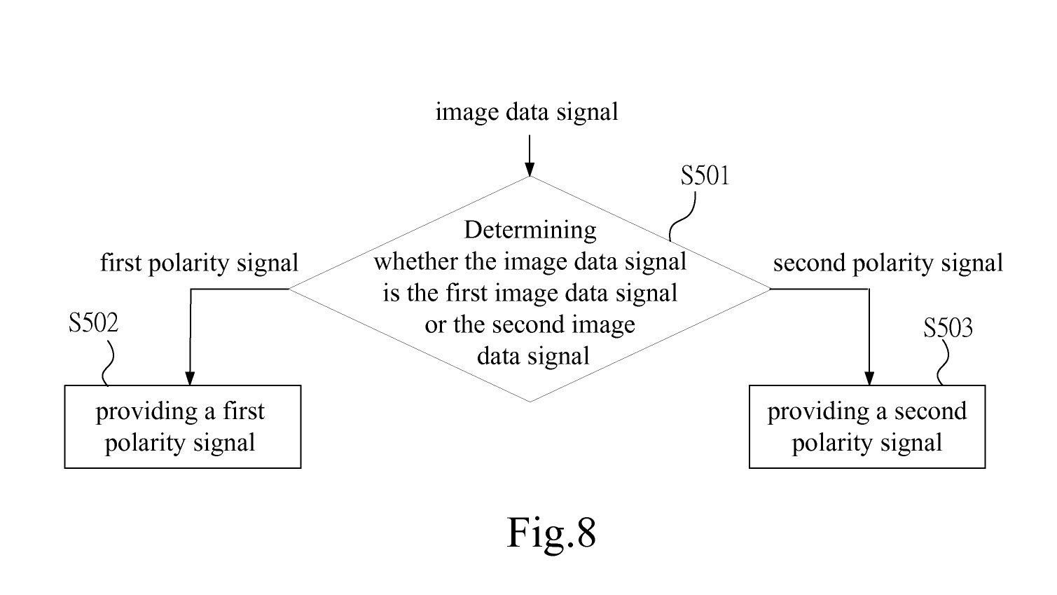

Referring to FIG. 8, a flow diagram showing a driving method according to one embodiment of the present invention is illustrated. When implementing the driving method of the LCD panel 100 of the present embodiment, firstly, it is determined whether the image data signal 302 is the first image data signal or the second image data signal (step S501). In this embodiment, the step S501 can be implemented by using the data processor 330 of the display controller 300, and the polarity control signal 305 can be transmitted to the control signal generator 350 according to the determined result, and thus the control signal generator 350 can correspondingly generate the first polarity signal or the second polarity signal to the LCD panel 100. When the image data signal 302 is determined as the first image data signal, the control signal generator 350 can provide the first polarity signal with higher frequency (step 502) for enhancing the display quality. When the image data signal 302 is determined as the second image data signal, the control signal generator 350 can provide the second polarity signal with lower frequency (step 503) for reducing the power consumption.

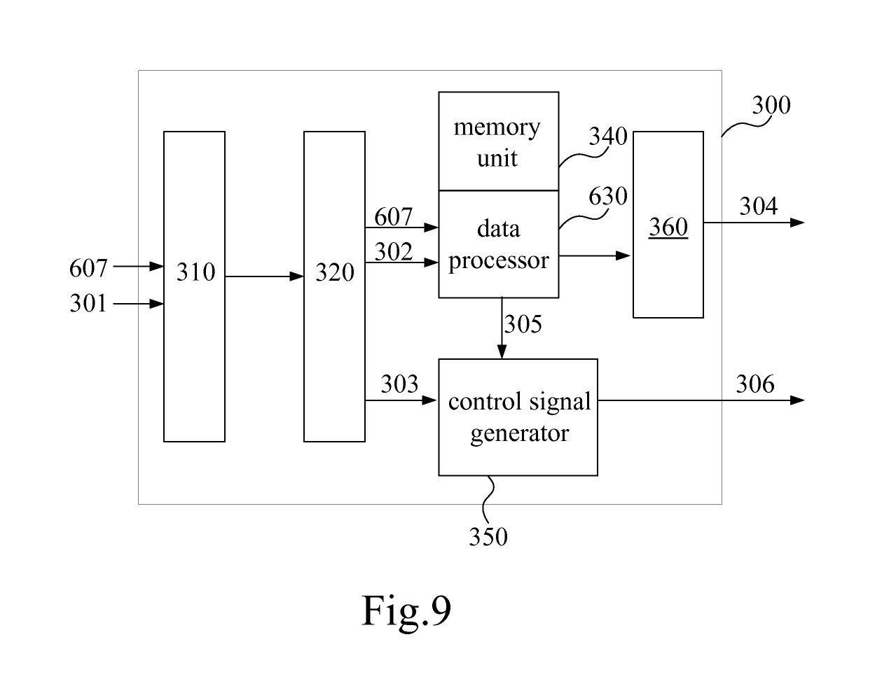

Referring to FIG. 9, a circuit block diagram showing the display controller according to another embodiment of the present invention is illustrated. In another embodiment, the image data signal 602 may be determined before being inputted to the display controller 300. For example, the step S501 can be implemented by using an external system terminal, a determining signal 607 can be transmitted to the data processor 630 of the display controller 300, and thus the data processor 630 can provide the polarity control signal 305 to the control signal generator 350 according to the determining signal 607, so as to provide the corresponding polarity signal to the LCD panel 100, thereby enhancing the display quality and reducing the power consumption.

As described above, the display controller and the driving method of the LCD panel of the present invention can provide the corresponding polarity signal having different frequencies according to the characteristic of the inputted image data signal (such as the static image signal or the dynamic image signal), so as to implement an appropriate polarity inversion, thereby enhancing the display quality and reducing the power consumption.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A display controller, electrically connected to a liquid crystal display panel, wherein the display controller comprises:
a data processor configured to process an image data signal; and
a control signal generator electrically connected to the data processor, wherein the control signal generator provides a first polarity signal to the liquid crystal display panel when the image data signal is a first image data signal, and the control signal generator provides a second polarity signal to the liquid crystal display panel when the image data signal is a second image data signal;
wherein a frequency of the first polarity signal is larger than a frequency of the second polarity signal.

2. The display controller as claimed in claim 1, wherein the first image data signal is a static image signal, and the second image data signal is a dynamic image signal.

3. The display controller as claimed in claim 1, wherein the data processor includes a determining unit for determining whether the image data signal is the first image data signal or the second image data signal, and transmitting a polarity control signal to the control signal generator.

4. The display controller as claimed in claim 3, wherein the determining unit includes a register for storing pixel data of the image data signal, and the image data signal is determined as the first image data signal when a variation ratio of the pixel data is less than a ratio threshold, and the image data signal is determined as the second image data signal when the variation ratio of the pixel data is larger than the ratio threshold.

5. The display controller as claimed in claim 4, wherein the number of the pixel data is 8, 16 or 32.

6. The display controller as claimed in claim 1, wherein the determining unit includes a register for storing pixel data of the image data signal, and the image data signal is determined as the first image data signal when a variation frequency of the pixel data is less than a ratio frequency, and the image data signal is determined as the second image data signal when the variation frequency of the pixel data is larger than the ratio frequency.

7. The display controller as claimed in claim 1, wherein the liquid crystal display panel implements dot inversion or two line inversion when the control signal generator provides the first polarity signal.

8. The display controller as claimed in claim 1, wherein the liquid crystal display panel implements frame inversion or column inversion when the control signal generator provides the second polarity signal.

9. The display controller as claimed in claim 1, wherein the image data signal is determined before being inputted to the display controller, and the data processor provides a polarity control signal to the control signal generator according to a determining signal.

10. The display controller as claimed in claim 1, wherein the control signal generator includes a multiplexer which outputs the first polarity signal or the second polarity signal according to a polarity control signal.

11. The display controller as claimed in claim 1, wherein the frequency of the first polarity signal is equal to the frequency of a loading signal.

12. The display controller as claimed in claim 1, wherein the frequency of the first polarity signal is one-half of the frequency of a loading signal.

13. The display controller as claimed in claim 1, wherein the frequency of the second polarity signal is one-half of a refresh frame frequency.

14. A method for driving a liquid crystal display panel comprising the following steps:
determining whether an image data signal is the first image data signal or a second image data signal;
providing a first polarity signal when the image data signal is determined as the first image data signal; and
providing a second polarity signal when the image data signal is determined as the second image data signal;
wherein the frequency of the first polarity signal is larger than the frequency of the second polarity signal.

15. The method as claimed in claim 14, wherein the first image data signal is a static image signal, and the second image data signal is a dynamic image signal.

16. The method as claimed in claim 14, wherein the image data signal is determined by using a determining unit of a data processor.

17. The method as claimed in claim 14, wherein the determining step comprises:
storing pixel data of a frame of the image data signal; and
comparing the pixel data of the frame with pixel data of a next frame for obtaining a variation ratio of the pixel data.

18. The method as claimed in claim 14, wherein the frequency of the first polarity signal is equal to the frequency of a loading signal.

19. The method as claimed in claim 14, wherein the frequency of the first polarity signal is one-half of the frequency of a loading signal.

20. The method as claimed in claim 14, wherein the frequency of the second polarity signal is one-half of a refresh frame frequency.
